(19) United States
(12) Patent Application Publication
(10) Pub. No.: US 2024/0238701 A1
(43) Pub. Date: Jul. 18, 2024

(54) FILTER ELEMENT ARRANGEMENT WITHIN A FILTER SYSTEM

(71) Applicant: John Crane UK Limited, Slough (GB)

(72) Inventors: Marco Vent, Schauenburg (DE); Gizem Beki Tarzan, Kassel (DE)

(21) Appl. No.: 18/415,975

(22) Filed: Jan. 18, 2024

Related U.S. Application Data
(60) Provisional application No. 63/480,430, filed on Jan. 18, 2023.

(51) Int. Cl. B01D 29/52; B01D 29/15; B01D 35/30

(52) U.S. Cl. CPC B01D 29/52; B01D 29/15; B01D 35/306; B01D 2201/0438; B01D 2201/4061

(57) ABSTRACT

A filter system includes a housing and a plurality of filter elements disposed in the housing. The plurality of filter elements includes one or more filter elements of a first filter element type and including one or more filter elements of a second filter element type. The system also includes a receptacle plate in the housing, the receptacle plate has at least two different mating elements for attaching filter elements thereto. The receptacle plate includes one or more first mating elements configured to mate with filter elements of the first type and one or more second mating elements configured to mate with filter elements of the second type.

### CROSS REFERENCE TO RELATED APPLICATION

This application claims the benefit of an earlier filing date from U.S. Provisional Application Ser. No. 63/480,430 filed Jan. 18, 2023, the entire disclosures of both which are incorporated herein by reference.

### BACKGROUND

Exemplary embodiments of the present disclosure pertain to the art of systems and methods for arranging filter elements in a filter.

Typical liquid filters can be used to filter impurities out of a liquid. An example of such a filter can include a filter housing with one or more filter cartridges. The liquid is flowed into the filter housing and typically flows from an outer diameter of the filter cartridges into the inner diameter. The flow of the liquid from the outer to inner diameter causes filter material in the filter element to clean the liquid. Cleaned liquid exits through an exit opening of the cartridge that is typically in the center of the filter cartridge.

### SUMMARY

The inventors hereof have discovered that by changing the arrangement of the filter elements within the housing, improved an filter-to-volume ratio can be achieved. In particular, the housing can include different sized filter elements arranged within in it that more completely fill the volume within the housing. The filter elements can also be referred to as filter candles (candles) or filter cartridges (cartridges). The filter elements can include any type of filter material therein.

Disclosed herein, by way of example, is a filter system. The system includes a filter housing that includes two or more types of filter elements disposed therein. In one embodiment, there are three different types of filter elements. Each type of filter element can include a particular attachment mechanism (e.g., threads or other fastener) that is different than others. For example, each type of filter element can have different sized attachment mechanisms.

The housing can include a receptacle plate that includes a pattern of connections that mate with filters. For example, the receptable plate can include two or three different sized receptacles that are different sizes so that only desired connections can be made as the connection will only accept one type of filter element attachment mechanism. This can help ensure that the filter elements are attached in only the correct locations.

Embodiments herein may be used to filter feedstock in polymer industry applications. As such, any filter cartridge disclosed herein can be used to filter feedstocks. Further, the teachings herein can be applied in any fluid filtration application including but not limited to hydrocarbon filtration.

In one embodiment, a filter system is disclosed. The system includes a housing and a plurality of filter elements disposed in the housing. The plurality of filter elements include one or more filter elements of a first filter element type and including one or more filter elements of a second filter element type. The system also includes a receptacle plate in the housing, the receptacle plate has at least two different mating elements for attaching filter elements thereto. The the receptacle plate includes one or more first mating elements configured to mate with filter elements of the first type and one or more second mating elements configured to mate with filter elements of the second type. The filter elements of the first type cannot mate with the second mating elements.

According to any prior embodiment, filter elements of the second type cannot mate with the first mating elements.

According to any prior embodiment, the first and second types of filter elements have different outer diameters.

According to any prior embodiment, the housing includes an inlet and an outlet and the filter elements all have inner diameters.

According to any prior embodiment, in operation, fluid flows from the inlet, through the outer diameters to the inner diameters and to the outlet.

According to any prior embodiment, the fluid flows through the receptacle plate before reaching the outlet.

According to any prior embodiment, the receptacle plate can be integrally formed in the housing or the receptacle plate can be a separate piece from the housing.

A second filter system is also disclosed. This system includes a housing and a plurality of filter elements disposed in the housing, the plurality of filter elements including one or more filter elements of a first filter element type and including one or more filter elements of a second filter element type. The system also includes a receptable plate as above. In this embodiment, the first and second types of filter elements have different outer diameters.

According to any prior embodiment, the receptacle plate can be integrally formed in the housing or the receptacle plate can be a separate piece from the housing.

According to any prior embodiment, housing includes an inlet and an outlet and the filter elements all have inner diameters.

According to any prior embodiment, in operation, fluid flows from the inlet, through the outer diameters to the inner diameters and to the outlet.

According to any prior embodiment, the fluid flows through the receptacle plate before reaching the outlet.

Also disclosed is method of filtering a liquid. The method includes: assembling a filter system. The filter system can by any system disclosed above or otherwise disclosed herein. In the method, assembly includes: disposing a plurality of filter elements in a housing, the plurality of filter elements including one or more filter elements of a first filter element type and including one or more filter elements of a second filter element type; and attaching the plurality of filter elements to a receptacle plate in the housing, the receptacle plate having at least two different mating elements for attaching filter elements thereto, wherein filter elements of the first element type are connected to first mating elements in the filter plate configured to mate with filter elements of the first type and filter elements of the second type are connected to second mating elements configured to mate with filter elements of the second type. The method also includes: providing a liquid at an inlet to the housing; passing the liquid through the plurality of filter elements; and passing cleaned liquid out of an outlet of the housing.

In the above method, filter elements of the first type cannot mate with the second mating elements.

In the above methods, filter elements of the second type cannot mate with the first mating elements.

In the above method, the first and second types of filter elements have different outer diameters.

In the above method, the liquid flows through the receptacle plate before reaching the outlet.

### BRIEF DESCRIPTION OF THE DRAWINGS

The following descriptions should not be considered limiting in any way. With reference to the accompanying drawings, like elements are numbered alike:

FIG. 1 shows a current arrangement of filter elements in a housing;

FIG. 2 shows a different arrangement of filter elements in a housing with different sized filter elements;

FIG. 3 shows a different arrangement of filter elements in a housing with different sized filter elements;

FIGS. 4A-4C show different views of the arrangement of FIG. 2;

FIGS. 5A-5C show different views of the arrangement of FIG. 3;

FIG. 6 shows an example receptacle plate; and

FIG. 7 shows another example receptacle plate.

### DETAILED DESCRIPTION

A detailed description of one or more embodiments of the disclosed apparatus and method are presented herein by way of exemplification and not limitation with reference to the Figures.

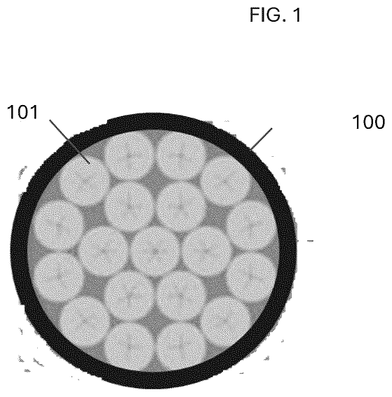

As noted above, FIG. 1 shows a cross section of one configuration of filter candles/filter elements 101 that can be contained in a housing 100. In the illustrated configuration, 19 filter elements 101 are provided in a housing. All filter elements 101 in FIG. 1 have a same shape/configuration. In this configuration if FIG. 1, the candles can achieve a packing density of 0.8. That is, there 20% of the internal volume of the housing where the candles are contained that is not filled by candles. Example candle OD's, and lengths are shown in Table 1 below but this is for explanation an not meant to be limiting.

TABLE 1

| | | | | | |
|---|---|---|---|---|---|
| | | | m² | m² | theor. |
| Candle | Candle | | per | over | Packing |
| OD | length | Amount | Candle | all | density |

19 Candle standard Pattern

| | | | | | |
|---|---|---|---|---|---|
| 60 | 735 | 19 | 0.49 | 9.31 | 0.8 |

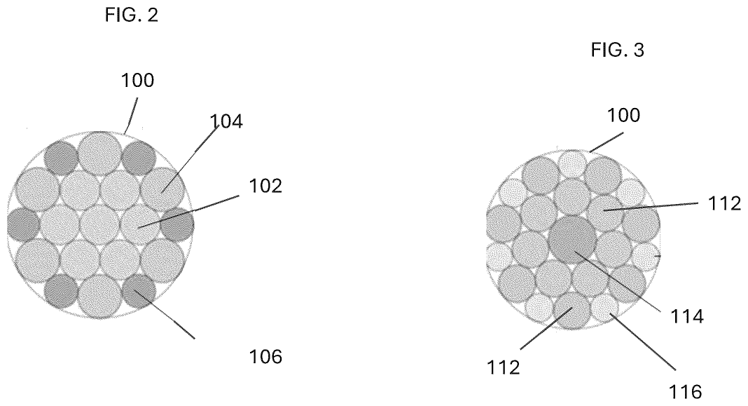

In embodiments herein, different sized filter elements are disposed within a housing. FIG. 2 shows an example of a cross section of three different sizes of filter elements. In the example in FIG. 2, 19 filter elements are provided in the housing. In this case, there are three different candles provided into the housing 100. The three different candles are labelled as candles 102, 104 and 106.

The corresponding sizes of the candles are shown in Table 2 below. Example candle OD's, and lengths are shown in Table 2 below but this is for explanation and not meant to be limiting.

TABLE 2

| | | | m² | m² | theor. |
|---|---|---|---|---|---|
| Candle | Candle | | per | over | Packing |
| OD | length | amount | Candle | all | density |
| 102→66 | 735 | 7 | 0.59 | 4.13 | 0.84 |
| 104→73 | 735 | 6 | 0.66 | 3.96 | |
| 106→55 | 735 | 6 | 0.47 | 2.82 | |
| | SUM | 19 | | 10.91 | |

In the configuration of FIG. 2, the candles may achieve a packing density of 0.84. That is, 16% of the internal volume of the housing where the filter elements 102, 104, 106 are contained is not filled by the filter elements 102, 104, 106.

FIG. 3 shows an example of a cross section of three different sizes of filter elements 112, 114, 116 arranged within the housing and that is slightly different than the arrangement of FIG. 3. In the example in FIG. 3, 22 filter elements are provided in the housing 100. In the configuration of FIG. 3, the corresponding sizes of the candles are shown in Table 3 below. Example candle OD's, and lengths are shown in Table 1 below but this is for explanation and not meant to be limiting.

TABLE 3

| | | | Approx . . . | | |
|---|---|---|---|---|---|
| | exampl. | | m² | m² | theor. |
| Candle | Candle | | per | over | Packing |
| OD | Length | amount | Candle | all | density |
| 112→63 | 735 | 14 | 0.55 | 7.7 | |
| 114→84 | 735 | 1 | 0.79 | 0.79 | 0.84 |
| 116→55 | 735 | 7 | 0.47 | 3.29 | |
| | SUM | 22 | | 11.78 | |

In this configuration, the filter elements 112, 114, 116 can achieve a packing density of 0.84. That is, 16% of the internal volume of the housing 100 where the filter elements 112, 114, 116 are contained is not filled by the filter elements 112, 114, 116.

It shall be understood that the example filter elements on FIGS. 1-3 are examples. Further, while not specifically called out, the accompanying figures show possible arrangements.

As shown, in FIG. 2 the first filter types 102 are surrounded by alternating second and third filter element types 104, 106 where the outer diameters of the filters are D104>D102>D106. In FIG. 3 the largest diameter filter element 114 is surrounded by the smaller elements 112, 116 where the outer diameters of the filters are D114>D112>D116 In all of the examples the lengths are the same but that could be varied.

In comparing configurations of FIGS. 2 and 3 it is noted that configuration of FIG. 3 may provide a greater volume of filter material in the column listed m².

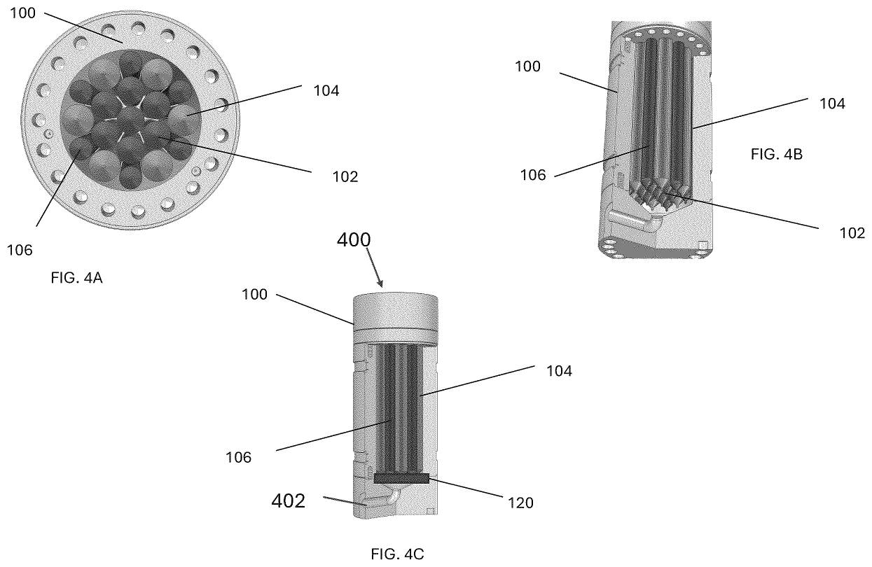

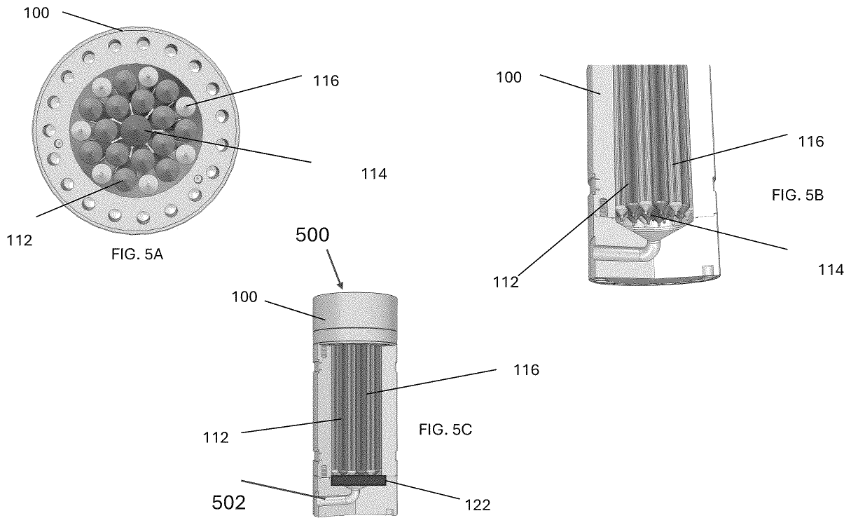

FIGS. 4A-4C show different views of the housing 100 with candles 102, 104 and 106. FIGS. 5A-5C show different views of the housing 100 with candles 112, 114 and 116.

With reference to both FIGS. 4A-4C and FIG. 5A-5C it shall be understood that each filter element can include threads or other fastener sized an configured to mate with corresponding mating elements in the receptacle plates 120, 122. This allows for the filter elements to be mated with the receptacle plates 120, 122 such that they are held in place in the housing 100. These patterns (or others) shown in FIGS. 2 and 3, respectively can thus be controlled by receptacle plates 120, 122 generally illustrated in FIGS. 4C and 5C.

Any of the filter elements herein can operate such that fluid flowed into the filter housing 100 flows from an outer diameter of the filter cartridges into the inner diameter. In FIGS. 4C and 5C, the fluid can generally enter the housing 100 by respective inlets 400, 500. The flow of the liquid from the outer to inner diameter causes filter material in the filter element to clean the liquid. Cleaned liquid exits through an exit opening of the cartridge that is typically in the center of the filter cartridge. In both FIGS. 4C and 5C, the liquid can pass through the receptacle plates 120,122 and exit the housing via outlets 402, 502.

The filter material can be any material suitable for cleaning the liquid. Suitable materials include a porous medium, for example. The porous medium can comprise a crosslinked polystyrene. The crosslinked polystyrene may be capable of adsorbing a surprising amount of degraded components, for example, including both soluble and insoluble oil oxidation by-products (such as polar byproducts resulting from degradation, such as hydrocarbon degradation) to extend the life of the hydrocarbon fluid.

The crosslinked polystyrene can be derived from at least a styrene monomer and a crosslinker. The styrene monomer can comprise one or both of styrene or a substituted styrene monomer (for example, alpha-methyl styrene, vinyl toluene, ethyl vinyl benzene, isopropenyl toluene, vinyl xylene, or vinyl naphthalene). The styrene monomer can comprise a halogenated styrene such as vinylbenzyl chloride. The crosslinked polystyrene can comprise repeat units derived from acrylonitrile, for example, comprising 1 to 4 mole percent of repeat units derived from acrylonitrile based on the total moles of repeat units of the crosslinked polystyrene.

The crosslinker can comprise at least one of divinyl benzene, divinyl toluene, trivinyl benzene, divinyl chloro benzene, diallyl phthalate, divinyl naphthalene, divinyl xylene, divinyl ethyl benzene, divinyl pyridine, divinyl sulfone, divinyl ketone, divinyl sulfide, ethylene glycol diacrylate, ethylene glycol dimethacrylate, trimethylol propane trimethacrylate, neopentyl glycol dimethacrylate, bisphenol A dimethacrylate, pentaerythritol tetramethacrylate, pentaerythritol trimethacrylate, allyl acrylate, diallyl maleate, diallyl fumarate, diallyl succinate, diallyl carbonate, diallyl malonate, diallyl oxalate, diallyl adipate, diallyl sebacate, divinyl sebacate, diallyl tartrate, diallyl silicate, triallyl tricarballylate, triallyl aconitate, triallyl citrate, triallyl phosphate, N,N′-methylene diacrylamide, N,N′-methylene dimethacrylamide, N,N′-ethylene diacrylamide, trivinyl naphthalene, or polyvinyl anthracene. The crosslinker can comprise at least one of divinyl benzene, divinyl toluene, trivinyl benzene, divinyl chloro benzene, diallyl phthalate, divinyl naphthalene, divinyl xylene, or divinyl ethyl benzene. The amount of the crosslinker can vary, but can be present in an amount sufficient to produce the crosslinked polystyrene having the desired pore volume or surface area.

The crosslinked polystyrene can be non-ionic, being free of both a cationic and an anionic functionality. In other words, the crosslinked polystyrene can be free of an ion exchange ability, which can help to avoid the release of water into the oil as a result of ion-exchange reaction for amine functionalized resins.

The crosslinked polystyrene can have a pore volume of greater than or equal to 0.6 mL/g, or 0.6 to 2 mL/g, or 0.75 to 1.5 mL/g as determined using the BET method using nitrogen adsorption at 77 Kelvin. The crosslinked polystyrene can have a surface area of 500 to 900 m²/g, or 500 to 850 m²/g, or 600 to 850 m²/g as determined in accordance with ISO 9277:2010. The crosslinked polystyrene can have an average pore size of 5 to 18 nanometers that can be determined using mercury porosimetry. The crosslinked polystyrene can be in the form of a plurality of beads or a porous plug. When in the form of beads, the bead size can have a mesh size of 16 to 50.

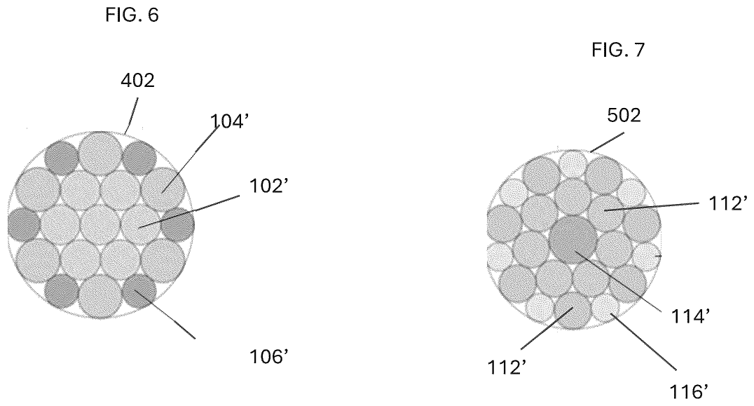

With reference now to FIGS. 6 and 7, examples of the receptacle plates 120, 122 are illustrated. As indicated, reference numbers that include a (′) attached to them in FIGS. 6 and 7 indicate that they refer to mating elements in them sized and arranged to mate with a particular filter element. For example, mating element 104′ is sized and arranged to mate with filter element 104, mating element 114′ is sized and arranged to mate with filter element 114 and so on. If the mating elements do not match the filter element, the filter element cannot mate with the mating element. Stated differently, in the case where there are two or more filter element types (e.g., first and second types) filter elements of the first type cannot mate with mating elements of the second type. Similarly, in this example, filter elements of the second type cannot mate with mating elements of the first type.

In one embodiment, the receptacle plates 120, 122 can be integrally formed as part of the housing. Alternatively, the receptacle plates 120, 122 can be separate elements.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A filter system comprising:
a housing;
a plurality of filter elements disposed in the housing, the plurality of filter elements including one or more filter elements of a first filter element type and including one or more filter elements of a second filter element type; and
a receptacle plate in the housing, the receptacle plate has at least two different mating elements for attaching filter elements thereto;
wherein the receptacle plate includes one or more first mating elements configured to mate with filter elements of the first type and one or more second mating elements configured to mate with filter elements of the second type;
wherein filter elements of the first type cannot mate with the second mating elements.

2. The system of claim 1, wherein filter elements of the second type cannot mate with the first mating elements.

3. The system of claim 1, wherein the first and second types of filter elements have different outer diameters.

4. The system of claim 3, wherein the housing includes an inlet and an outlet and wherein the filter elements all have inner diameters.

5. The system of claim 4, wherein, in operation, fluid flows from the inlet, through the outer diameters to the inner diameters and to the outlet.

6. The system of claim 5, wherein the fluid flows through the receptacle plate before reaching the outlet.

7. The system of claim 1, wherein the receptacle plate is integrally formed in the housing.

8. The system of claim 1, wherein the receptacle plate is a separate piece from the housing.

9. A filter system comprising:
a housing;
a plurality of filter elements disposed in the housing, the plurality of filter elements including one or more filter elements of a first filter element type and including one or more filter elements of a second filter element type; and
a receptacle plate in the housing, the receptacle plate has at least two different mating elements for attaching filter elements thereto;
wherein the receptacle plate includes one or more first mating elements configured to mate with filter elements of the first type and one or more second mating elements configured to mate with filter elements of the second type;
wherein the first and second types of filter elements have different outer diameters.

10. The system of claim 9, wherein the housing includes an inlet and an outlet and the filter elements all have inner diameters.

11. The system of claim 10, wherein, in operation, fluid flows from the inlet, through the outer diameters to the inner diameters and to the outlet.

12. The system of claim 11, wherein the fluid flows through the receptacle plate before reaching the outlet.

13. The system of claim 9, wherein the receptacle plate is integrally formed in the housing.

14. The system of claim 9, wherein the receptacle plate is a separate piece from the housing.

15. A method of filtering a liquid, the method comprising:
assembling a filter system, wherein assembling includes:
disposing a plurality of filter elements in a housing, the plurality of filter elements including one or more filter elements of a first filter element type and including one or more filter elements of a second filter element type; and
attaching the plurality of filter elements to a receptacle plate in the housing, the receptacle plate having at least two different mating elements for attaching filter elements thereto, wherein filter elements of the first element type are connected to first mating elements in the filter plate configured to mate with filter elements of the first type and filter elements of the second type are connected to second mating elements configured to mate with filter elements of the second type;
providing a liquid at an inlet to the housing;
passing the liquid through the plurality of filter elements; and
passing cleaned liquid out of an outlet of the housing.

16. The method of claim 15, wherein filter elements of the first type cannot mate with the second mating elements.

17. The method of claim 16, wherein filter elements of the second type cannot mate with the first mating elements.

18. The method of claim 15, wherein the first and second types of filter elements have different outer diameters.

19. The method of claim 18, wherein the liquid flows through the receptacle plate before reaching the outlet.
